(19) United States
(12) Patent Application Publication
(10) Pub. No.: US 2008/0147652 A1
(43) Pub. Date: Jun. 19, 2008

(54) PHYSICAL ADDRESS VERIFICATION WITHIN ELECTRONIC DOCUMENTS

(75) Inventor: Mark Kirkpatrick, Conyers, GA (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/610,915

(22) Filed: Dec. 14, 2006

(51) Int. Cl. G06F 17/30

(52) U.S. Cl. 707/6; 707/E17.014

(57) ABSTRACT

Physical addresses entered into electronic documents such as letters, electronic mail messages, web pages, and the like are verified as the correct address. The physical address is identified as such, by manual selection or pattern matching to expected address formats. The identified address is then compared to a library of physical addresses to determine if exact or close matches exist. The user is then provided with an indication of whether there is an exact match and/or whether close matches exist. Options may be provided such as to replace the identified physical address within the document with one of the close matches, map one or more of the addresses, save the addresses to recently used lists, and add an identified address to a library.

### TECHNICAL FIELD

Embodiments relate to the verification of information within an electronic document. More particularly, the embodiments relate to the verification of physical addresses entered into electronic documents.

### BACKGROUND

Physical addresses such as for businesses or residences contain multiple strings of characters including letters and numbers. Typically a physical address includes several components. In the United States, a physical address includes a street number, a street name, a city, a state, a zip code number, and possibly additional information such as a suite number or name, a street type, and a street direction. Other countries may have different formats but generally include a collection of numbers and/or words to form a physical address.

Physical addresses are often needed in electronic documents. For example, a physical address is often included in a letter being generated within a word processing computer application, in an electronic mail (email) message being generated within an email client computer application, within a web page document being generated within a web page creator computer application, and in similar electronic documents of other computer applications.

When entering physical addresses into electronic documents, such entry usually being a manual task of typing the information of the physical address, each of the components needs to be correct in order for the complete physical address to be correct. While a spellchecker may determine that individual words are misspelled, a spellchecker cannot identify if a collection of numbers and words forming a physical address correctly form a true physical address or a desired physical address. Thus, even if all words of a physical address within an electronic document are correct, the physical address of the electronic document may not be a true physical address and/or may not be the desired physical address. Furthermore, one or more words of a physical address may be a proper name that is not a word that is present in a spellchecker dictionary.

### SUMMARY

Embodiments address these issues and others by verifying physical addresses of electronic documents. The physical address is identified within the electronic document, such as by manual selection by a user or by pattern recognition, and is then checked against a library of physical addresses to determine whether there is a match and/or to find close matches. An indication of whether an exact match is found and/or whether close matches are found may be provided so that the user may determine whether a correct is necessary.

Embodiments include a device for verifying a physical address entered into an electronic document includes memory containing the electronic document and at least one input device. A processor is configured to implement an application program that generates an electronic document. The processor is configured to receive user input to create a physical address within the electronic document, to determine a physical address to be verified from the electronic document, to access a library of physical addresses, to compare the physical address to be verified to the physical addresses of the library to determine whether the physical address to be verified matches a physical address of the library, and to provide an indication of whether the physical address to be verified matches a physical address of the library.

Embodiments include a computer-implemented method for verifying a physical address entered into an electronic document involves receiving user input to create an electronic document. A physical address is identified within the electronic document being created, and the physical address is compared to a library of physical addresses. When the identified physical address matches a physical address of the library, an indication of the match is provided. When the identified physical address does not match any physical address of the library, an indication of no exact match is provided.

Embodiments include a computer readable medium containing instructions that perform acts that involve receiving user input to create an electronic document. The acts further involve identifying a physical address within the electronic document being created and comparing the physical address to a library of physical addresses. Additionally, the acts involve producing an indicator of whether a match to the physical address has been found.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE DRAWINGS

FIG. 1 shows one example of a computer network with a computer system having local and/or remote libraries for verifying physical addresses entered into electronic documents being generated on the computer system.

FIG. 2 shows one example of logical operations of the computer system for verifying the physical address.

FIG. 3 shows one example of an interface format for communicating between the address checking logic and the library of physical addresses.

FIG. 4 shows one example of an electronic document with a physical address before and after undergoing verification that results in finding an exact match.

FIG. 5 shows one example of an electronic document with a physical address before and after undergoing verification that results in not finding an exact match but finding close matches.

### DETAILED DESCRIPTION

According to various embodiments disclosed herein, physical addresses within electronic documents being created by users are verified by identifying the physical address through a manual or automated manner. Then the identified physical address is referenced within a library of real physical addresses to find exact and/or close matches. The user may be presented with an indication of the exact match and/or close matches so that the user may decide what the proper physical address for the electronic document is. The user may be further given the opportunity to select a close match as a replacement for the identified physical address.

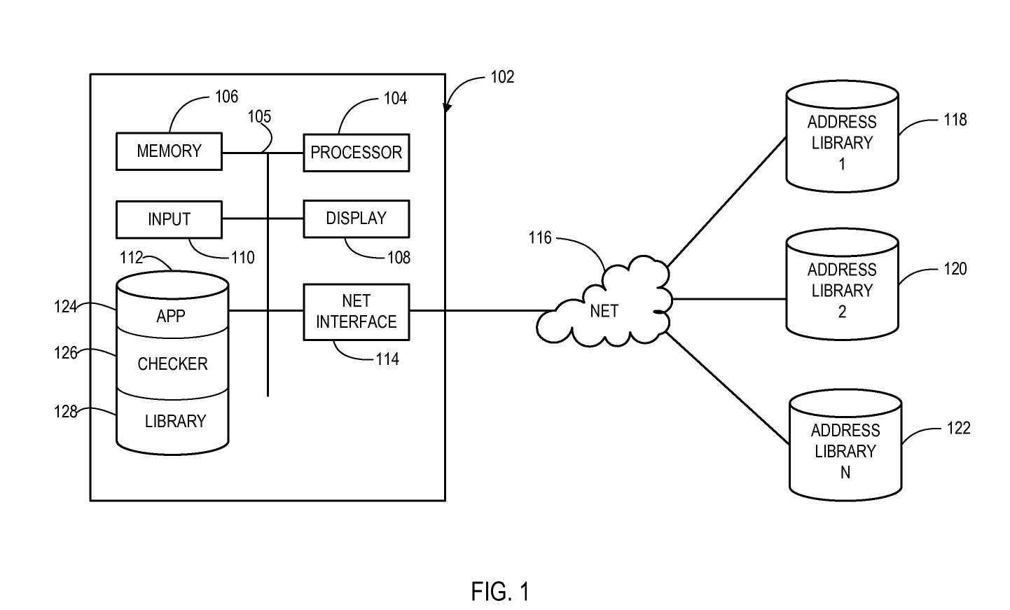

FIG. 1 shows a computer system 102 that may be used to generate electronic documents that contain physical addresses. The computer system 102 may employ logic to identify the physical addresses and verify whether they are correct. In doing so, the computer system 102 may resort to one or more libraries of physical addresses, including local and/or remote libraries. When accessing remote libraries, the computer system 102 may communicate with external computer systems having libraries 118, 120, 122 over a network 116 such as the Internet or an Intranet. Examples of a computer system 102 include personal computers, server computers, handheld computers, PDAs, smart phones, and the like.

The computer system 102 may include various components that communicate over a data bus. The components may include a processor 204 which may be either a general purpose programmable processor or an application specific processor. Accordingly, the processor 204 may implement hard-wired logic and/or logic obtained from a memory device 106 and/or a storage device 112 to perform various functions.

The processor 204, memory 106, and storage device 112 are examples of computer readable media which store instructions that when performed implement various logical operations. Such computer readable media may include various forms of storage media including electronic, magnetic, and optical storage. Computer readable media may also include various forms of communications media, such as wired and wireless connections used to transfer the instructions or send and receive other data messages.

The processor 104 may implement an application program 124 such as a word processor, an electronic mail client, a web page creation program, and so forth that provides a user with the opportunity to enter text and other information. For example, the user may enter text via an input device 110 into an electronic document being generated within the application program. The entered text may be a physical address that is to be verified. The input device may take various forms such as a keyboard, a mouse, or a stylus in combination with touchscreen. The electronic document may be visually displayed on a display device 108.

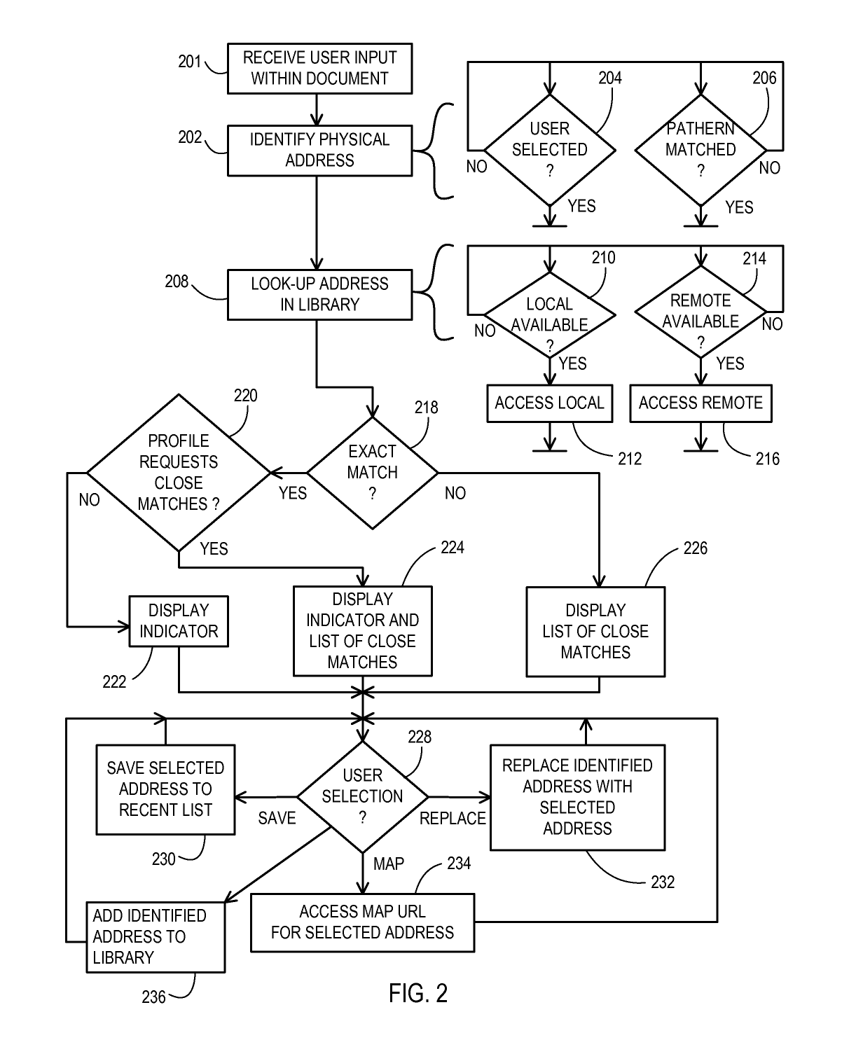

In order to verify the physical addresses, a physical address checker 126 may also be included. The physical address checker 126 provides the instructions to perform a set of logical operations such as the example discussed below in relation to FIG. 2. The physical address checker 126 may be present in various forms. For example, the physical address checker 126 may be an integral portion of an application 124 being used to create the electronic document. As another example, the physical address checker 126 may be a stand-alone module that may be called upon by multiple applications in order to perform the physical address checking within electronic documents on behalf of the multiple applications. Furthermore, for some instances where remote libraries are used, the checker 126 may be partially present within the local computer system 102 while complementary logic of the checker 126 is present at the remote libraries 118, 120, 122.

For examples where the checker 126 accesses local libraries, those libraries 128 may be stored on the local storage device 112, such as a hard disk drive, a compact disc, or a digital versatile disc. When the checker 126 accesses remote libraries 118, 120, 122, the checker 126 may utilize a network interface 114 of the computer system 102. The network interface 114 may include a wired connection or wireless connection to an external network 116. For example, in the case of a personal computer, the network interface 114 may be an Ethernet or Wi-Fi connection. As another example, in the case of a mobile device such as a smart phone, the network interface 114 may be a cellular air interface.

FIG. 2 shows one example of a set of logical operations that may be performed by the computer system 102 in order to verify the physical addresses that the user has entered into the electronic documents being created. Initially, the computer system 102 receives user input to open the electronic document, either as a new document or a document being re-opened, and to enter information into the electronic document at input operation 201. The computer system 102 then identifies a physical address that is entered within the electronic document at address operation 202.

In order to identify the physical address, various alternatives may be employed. The application program may expose a physical address option upon a user selecting text within the electronic document and then performing a right-click of a mouse or a similar activity to thereby indicate to the application program that the selected text is a physical address that should be verified. In that case, the computer system detects whether the user has selected text and the physical address checker option at query operation 204.

As an alternative, the application program may employ a pattern matching analysis after each character is entered in order to find text within the electronic document that matches a known pattern for physical addresses. There may be a number of expected formats of a physical address and a pattern match analysis may be attempted for each of the expected formats. For example, one United States expected format might be a street number followed by a street name directly above a city name, a state name, and/or a zip code. As another example, a second United States expected format might be a street number followed by a street name, a comma or other separator, a city name, a state name, and/or a zip code. In this alternative, the computer system detects whether a pattern for an expected address format has been matched at query operation 206.

Once the computer system has determined that a physical address has been identified, either by user input to select the text for some embodiments or by a pattern match for the same or other embodiments, then the computer system performs a look-up of the identified physical address in a library at look-up operation 208. As previously discussed, the library may be local or remote. The checker module 126 may maintain a set of preferences set by the user, and those preferences may specify whether to use only a local library, only a remote library, a combination of local and remote libraries, and so forth.

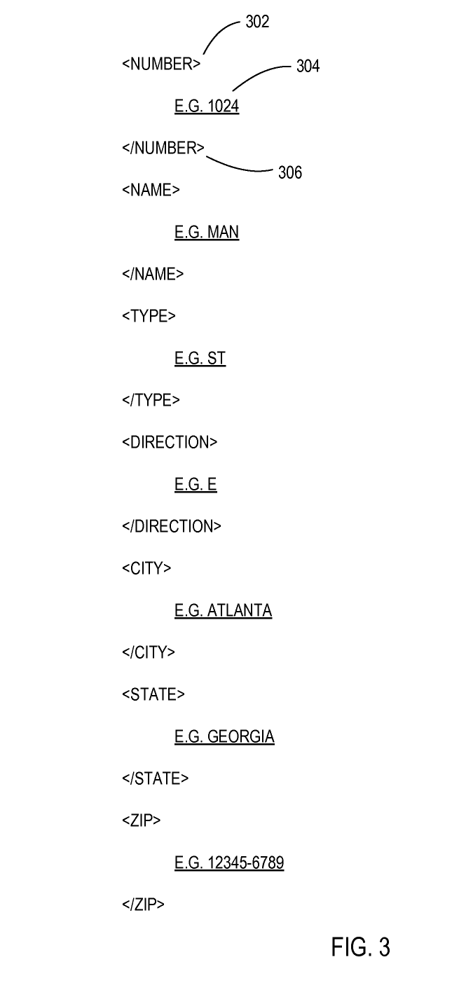

For embodiments where a local library is to be checked, query operation 210 detects whether a local library is available. If so, then the computer system 102 accesses the local library at access operation 212 in order to determine whether any exact or close matches exist for the identified physical address. The particular interface for the query from the checker module 126 to the local library 128 may be of various forms. However, one example in mark-up language format is discussed below in relation to FIG. 3.

For embodiments where a remote library is to be checked, query operation 214 detects whether a remote library is available. A remote library's network address, such as an Internet Protocol (IP) address, may be maintained in memory, specified by user preference or stored as a default within the checker module 126. This network address, if available, allows the computer system 102 to query the remote library. If the remote library is available, e.g., a network address is known and the remote library server responds to an acknowledgement request, the computer system 102 may then attempt to access the remote library to allow the remote library to determine whether any exact or close matches exist for the identified physical address. As with the local library, the particular interface for the query from the checker module 126 to the remote library 118, 120, 122 may be of various forms and FIG. 3 shows one such example.

At query operation 218, the computer system detects whether an exact match has been found by accessing the local and/or remote libraries. If an exact match is not found, then according to embodiments such as the one shown, the computer system displays a list of close matches that have been returned from the local and/or remote libraries at display operation 226. An example of a display of close matches is discussed below in relation to FIG. 5.

The determination of whether a physical address of the local or remote library is a close match may be made, either as a service provided by the library being queried or by logic of the checker module 126 itself. Furthermore, the criteria for finding a close match may be set as a default, may be user specified, or may be a combination. For example, a close match may be specified as one where the street name and city name match but the street number varies by no more than a given number of digits. Likewise, a close match may be specified as one where the street number and the city name match but the street name varies by no more than a given number of letters. As yet another example of a close match, the street number, street name, and city may match but the street direction and/or the street type may differ.

Where the computer system finds that there is an exact match, then according to the embodiment shown, the computer system then determines whether the user profile requests that close matches also be displayed in addition to indicating that an exact match has been found. A user may choose for this to occur because the user may type a wrong address that still has an exact match. By seeing a list of close matches, the user may recognize that the correct physical address is one from the list of close matches so that the identified physical address of the electronic document may be replaced by the correct physical address even though the identified physical address of the document had an exact match from a library.

If the computer system detects that the user has opted not to display close matches when an exact match is found, then an indicator of the exact match is displayed at display operation 222. The indicator may be of various forms. For example, the indicator may be a change to the appearance of the text forming the physical address, such as by changing the text to a particular color, making the text a bolder font, or even displaying a dialog box nearby that states that an exact match has been found.

If the computer system detects that the user has opted to display close matches when an exact match is found, then an indicator of the exact match is displayed along with a list of the close matches at display operation 224. Thus, the user is given the opportunity to replace the identified physical address if it happens to be incorrect even though it did have an exact match.

When displaying the indicators and/or list of close matches, the computer system 102 may also display various options related to the physical address that the user may select. For example, the options may include a save option, to save the address to a list of recently used or frequently used physical addresses. This saved list may be used to recall addresses for use in future documents and/or to alter the list of close matches. If a physical address being verified has a list of close matches, one of which is found in the recently used list, then the recently used close match may be listed first or otherwise indicated as the more likely correct choice than other close matches. If the user selects the save option, then the computer system 102 detects the selection at query operation 228, and the computer system 102 saves the selected physical address, either the identified address or one of the close matches, to the recently used list at save operation 230.

As another example of the options, an add address option may be provided to allow the user to add a physical address known to be valid to the library when no exact match is found. If the user selects the add option, then the computer system 102 detects the selection at query operation 228, and the computer system 102 adds the address to the library, either local or remote, such as by using an interface format like that of FIG. 3 but in a request to add rather than a request to find matches at add operation 236.

As another example of the options, a replace address option may be provided to allow the user to replace the identified physical address of the electronic document with one of the close matches being displayed. If the user selects the replace option, then the computer system 102 detects the selection at query operation 228, and the computer system 102 replaces the text forming the identified physical address with the text forming the close match at replace operation 232.

As yet another example of the options, a map address option may be provided to allow the user to map a selected physical address, such as the identified physical address of the document or one of the close matches, if any. If the user selects the map option, then the computer system 102 detects the selection at query operation 228, and the computer system 102 displays a map obtained either from a local mapping application or from a remote mapping application at map operation 234. For example, the computer system 102 may access an Internet mapping service by providing the selected physical address to a particular network address or universal resource locator (URL).

FIG. 3 shows one example of a format for interfacing with a library. The checker module 126 may package the identified address in the mark-up manner shown in FIG. 3. Likewise, the library may respond with each of the exact and/or close matches also packaged in the mark-up manner shown. In this example, each component of an expected format of a physical address has its own start tag 302 and end tag 306, with the actual text 304 for that component being located between the tags. Thus, an expected address format in the United States has a street number, which has a start tag 302, the text of this particular component of the identified physical address, e.g., 1024, and an end tag 306. Accordingly, the library can look for addresses with text of one tag matching the text of the same tag for the stored addresses. Similarly, the application can replace text of a physical address by inserting the text for each of the tags in place of the corresponding text for the physical address identified within the electronic document.

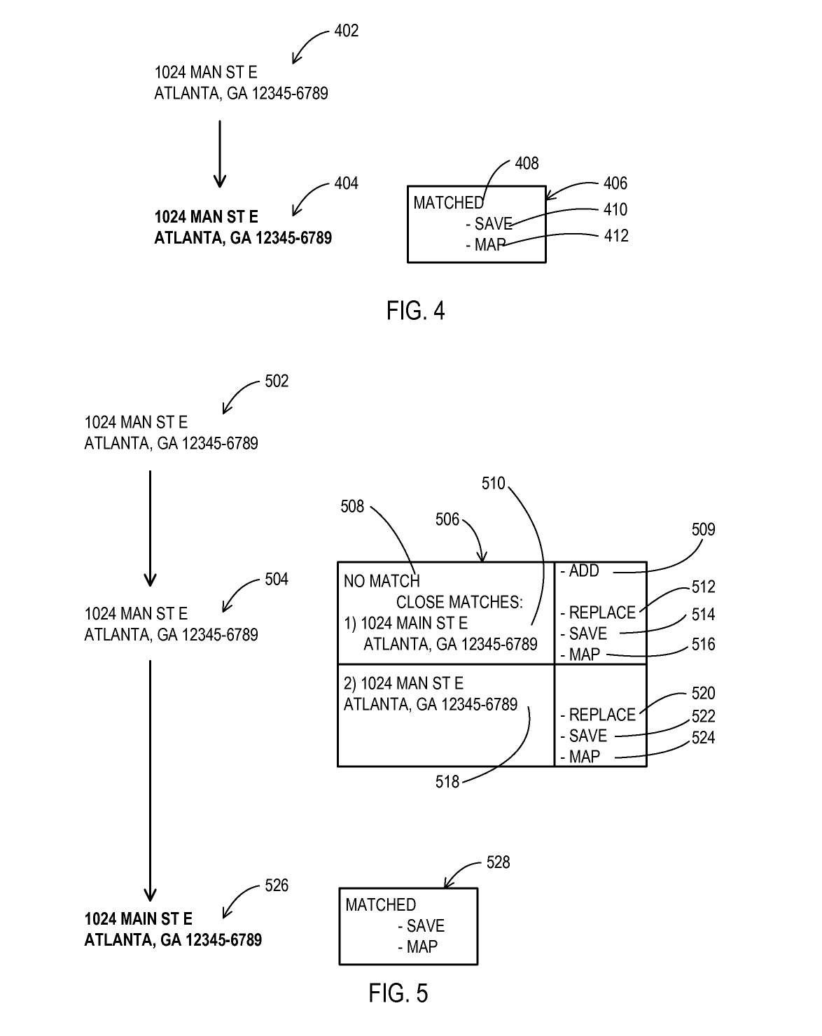

FIG. 4 shows an example of text 402 of an electronic document that has been identified as a physical address. After execution of the logical operations of FIG. 2, it is found that the identified physical address 402 has an exact match and the identified physical address is now displayed with indicators. One indicator of this example is the bold text 404. Another indicator is the “Matched” statement 408 within a dialog box 406 displayed alongside the physical address. The dialog box also displays links 410 and 412 that provide the save and map options. Since in this example there was an exact match and the user has chosen not to display close matches when an exact match is found, there are no options to add or replace.

FIG. 5 shows an example of text 504 of an electronic document that has been identified as a physical address. After execution of the logical operations of FIG. 2, it is found that the identified physical address 504 has no exact match but does have close matches. The text 504 remains the same as the text 502 as the physical address has not been matched and has not been replaced. A dialog box 506 is displayed alongside the text 504. A statement “No Match” 508 also indicates that no exact match has been found. However, a link 509 provides the user with an add option to add the identified physical address 504 to the library if the user knows that the address 504 is correct.

The dialog box 506 also displays two close matches, 510, 518. Each close match has a set of links for replace 512, 520, save 514, 522, and map 516, 524. As can be seen, the first close match 510 differs from the identified physical address by one letter in the street name. The second close match 518 differs from the identified physical address by one number in the zip code. If the user finds that one of the close matches is the intended physical address, then the user may select the replace link 512, 520 of the appropriate close match to replace the text 504 with the close match 510, 518. The user may choose to map each of the close matches 510, 518 to make a more informed choice as to which close match is the correct one.

In this example, the user has decided that the first close match 510 is the correct one and has selected replace link 512. The text 504 is now replaced by text 526. The computer system 102 may display an indicator that the address text 526 is verified as having an exact match by displaying the text bolder as shown, in a different color, etc. Furthermore, the computer system 102 may display the dialog box 528 containing information like that discussed in relation to the dialog box 406 of FIG. 4.

Thus, computer system users who generate electronic documents that include physical addresses may utilize the address checker to verify that the physical addresses added to the electronic document are correct addresses. The user may take advantage of the various features to map, save, add, and so forth to have a robust physical address verification system.

While various embodiments have been particularly shown and described, it will be understood by those skilled in the art that various other changes in the form and details may be made therein without departing from the spirit and scope of the invention

What is claimed is:

1. A device for verifying a physical address entered into an electronic document, comprising:
memory containing the electronic document;
at least one input device; and
a processor configured to implement an application program that generates an electronic document, the processor being configured to receive user input to create a physical address within the electronic document, to determine a physical address to be verified from the electronic document, to access a library of physical addresses, to compare the physical address to be verified to the physical addresses of the library to determine whether the physical address to be verified matches a physical address of the library, and to provide an indication of whether the physical address to be verified matches a physical address of the library.

2. The device of claim 1, wherein the processor is further configured to provide a list of close matches to the determined physical address of the electronic document.

3. The device of claim 2, wherein the processor determines whether a user profile specifies to provide the list of close matches when an exact match is found for the determined physical address and then provides the list of close matches in accordance with the user profile.

4. The device of claim 1, wherein the processor determines the physical address to be verified by receiving user input to identify the physical address.

5. The device of claim 1, wherein the processor determines the physical address to be verified by performing an analysis of character strings entered into the electronic document relative to an expected physical address format.

6. The device of claim 1, wherein the processor is configured to alter the appearance of the determined physical address upon finding a match for the physical address.

7. The device of claim 1, further comprising a storage device containing the library of physical addresses and wherein the processor is configured to access the library from the storage device.

8. The device of claim 1, further comprising a network interface and wherein the processor is configured to access the library from a network address via the network interface.

9. A computer-implemented method for verifying a physical address entered into an electronic document, comprising:
receiving user input to create an electronic document;
identifying a physical address within the electronic document being created;
comparing the physical address to a library of physical addresses;
when the identified physical address matches a physical address of the library, providing an indication of the match; and
when the identified physical address does not match any physical address of the library, providing an indication of no exact match.

10. The computer-implemented method of claim 9, further comprising, when the identified physical address does not match any physical address of the library, providing at least one close match.

11. The computer-implemented method of claim 9, further comprising, when the identified physical address does match a physical address of the library, providing at least one close match.

12. The computer-implemented method of claim 9, wherein identifying the physical address comprises receiving user input to identify the physical address.

13. The computer-implemented method of claim 9, wherein identifying the physical address comprises performing an analysis of character strings entered into the electronic document relative to an expected physical address format.

15. The computer-implemented method of claim 9, further comprising accessing the library from the storage device.

16. The computer-implemented method of claim 9, further comprising accessing the library from a network address.

17. A computer readable medium containing instructions that perform acts comprising:
receiving user input to create an electronic document;
identifying a physical address within the electronic document being created;
comparing the physical address to a library of physical addresses;
producing an indicator of whether a match to the physical address has been found.

18. The computer readable medium of claim 17, wherein the indicator comprises an alteration of the physical address identified within the electronic document when an exact match to the physical address is found and the indicator comprises a list of close matches when an exact match to the physical location is not found.

19. The computer readable medium of claim 18, further comprising:
receiving a selection of one of the close matches; and
replacing the identified physical address with the selected close match.

20. The computer readable medium of claim 19, further comprising, when the identified physical address has a match, then saving the identified physical address in a recent physical address list and when a close match is selected, then saving the selected close match to the recent physical address list.
